(19) United States
(12) Patent Application Publication
(10) Pub. No.: US 2026/0218680 A1
(43) Pub. Date: Jul. 30, 2026

(54) CONTROLLING WIND TURBINE ROTOR BLADE PITCH IN ACCORDANCE WITH A DYNAMIC MAXIMUM PITCH AMPLITUDE VALUE

(71) Applicant: VESTAS WIND SYSTEMS A/S, Aarhus N (DK)

(72) Inventors: Alexander Duncan GILES, Porto (PT); Jesper Sandberg THOMSEN, Hadsten (DK); Bruno Martins CUNHA, Guimarães (PT)

(21) Appl. No.: 19/141,207

(22) PCT Filed: Dec. 20, 2023
(86) PCT No.: PCT/DK2023/050320

§ 371 Date: Jun. 19, 2025

(30) Foreign Application Priority Data
Dec. 21, 2022 (DK) PA202270638

(51) Int. Cl. F03D 7/02

(52) U.S. Cl. CPC F03D 7/0224; F05B 2270/328; F05B 2270/331; F05B 2270/335

(57) ABSTRACT

The invention relates to adjusting pitch of wind turbine rotor blades. A wind turbine controller includes a collective pitch control module for determining a collective pitch reference, and one or more pitch offset control modules. The controller receives a 5 collective pitch signal indicative of collective pitch angle of the rotor blades; receives a power signal indicative of power output of the wind turbine; and, for each of the one or more pitch offset control modules, determines a respective dynamic maximum pitch amplitude value based on the received collective pitch signal and power signal. Each pitch offset control module determines a respective pitch reference offset value in accordance 10 with the respective dynamic maximum pitch amplitude value. The controller determines an overall pitch reference based on the collective pitch reference and the one or more pitch reference offset values. [FIG. 5] 15

### TECHNICAL FIELD

The invention relates to controlling pitch of rotor blades of a wind turbine and, in particular, to controlling pitch in accordance with one or more dynamic maximum pitch amplitude values.

### BACKGROUND

Wind turbines as known in the art include a wind turbine tower supporting a nacelle and a rotor with a number of—typically, three—pitch-adjustable rotor blades mounted thereto. A wind turbine is prone to vibrations, such as tower, nacelle, or rotor blade movement. It is known that certain types of vibrations may be damped by active pitching of the rotor blades or adjusting generator torque. Control strategies for adjusting blade pitch can be used to maximise energy production of a wind turbine while minimising loads experienced by various components of the wind turbine.

Rotor blades may be adjusted as part of a collective pitch control routine, in which each of the rotor blades is adjusted in the same way at the same time, where such a collective pitch controller may be used to control wind turbine rotor speed, for instance. A wind turbine may include one or more pitch modification or offset controllers each for determining a respective offset to a collective pitch reference output by the collective pitch controller. Each pitch offset controller may be for mitigating respective frequency content associated with a component of the wind turbine associated with extreme or fatigue component loading in order to alleviate the loading. The pitch offset obtained from each pitch offset controller may be in the form a collective pitch offset, in which the same offset value is applied to each rotor blade, or an individual or cyclic pitch offset, in which each blade has its own respective offset value applied. The collective pitch reference and the one or more pitch offset signals may be combined to obtain an overall pitch reference for collective and/or individual pitch adjustment of the rotor blades.

The pitch system of a wind turbine may be a hydraulic pitch system used to actuate the rotor blades in accordance with the overall pitch reference. The amount of pitch control that may be performed is limited by a pump capacity of the hydraulic pitch system. The demand placed on the pump system is a function of both the amplitude and frequency of pitch adjustment. In particular, pitch adjustment of both high amplitude and high frequency places a high demand on the pump system. Typically, each pitch offset controller has a respective maximum pitch amplitude defining a maximum amplitude of offset adjustment permitted by said controller. This is to ensure that the hydraulic pitch system does not demand more than can be delivered by the pump system. However, constraining the amplitude adjustment of each pitch offset controller in this way may limit the effectiveness of the respective controller in alleviating certain loads, and may not effectively or efficiently utilise the overall capacity of the pump system. Furthermore, constraining the amplitude adjustment of each pitch offset controller in this way may result in fretting of the blade bearing during periods in which there are only relatively small movements in pitch angle, thereby creating lubrication issues.

It is against this background to which the present invention is set.

### SUMMARY OF THE INVENTION

According to an aspect of the present invention there is provided a controller for a wind turbine having a rotor and two or more rotor blades. The controller is for adjusting pitch of the rotor blades. The controller comprises a collective pitch control module for determining a collective pitch reference for the rotor blades. The controller comprises one or more pitch offset control modules. The controller is configured to receive a collective pitch signal indicative of collective pitch angle of the rotor blades. The controller is configured to receive a power signal indicative of power output of the wind turbine. For each of the one or more pitch offset control modules, the controller is configured to determine a respective dynamic maximum pitch amplitude value based on the received collective pitch signal and on the received power signal. Each pitch offset control module is configured to determine a respective pitch reference offset value in accordance with the respective dynamic maximum pitch amplitude value. The controller is configured to determine an overall pitch reference based on the collective pitch reference and the one or more pitch reference offset values. The controller may be configured to transmit a control signal to adjust the pitch of the rotor blades in accordance with the overall pitch reference.

The one or more pitch offset control modules may comprise one or more tilt-yaw individual pitch offset control modules each for mitigating loads experienced by one or more components of the wind turbine. The one or more tilt-yaw individual pitch offset control modules may comprise a 1P pitch offset control module configured to: receive an out-of-plane load signal, from a sensor of one or more of the rotor blades, indicative of out-of-plane loading on each of the respective rotor blades; and, determine a 1P pitch reference offset value for each respective rotor blade, based on the received out-of-plane load signals, to target 1P frequency content in the received out-of-plane load signal. The one or more tilt-yaw individual pitch offset control modules may comprise a 2P pitch offset control module configured to: receive the out-of-plane load signals; and, determine a 2P pitch reference offset value for each respective rotor blade, based on the received out-of-plane load signals, to target 2P frequency content in the received out-of-plane load signal.

The controller may be configured to determine a statistical dispersion parameter of out-of-plane (e.g. flap) loading for each of the rotor blades, the statistical dispersion parameters being indicative of a turbulence level in a wind field in which the wind turbine operates. The determination may be based on one or more of: the received out-of-plane (e.g. flap) load signals; or, a signal received from a nacelle- or tower-based sensors, such as a measurement of fore-aft acceleration of the wind turbine tower, or main shaft signals (tilt and yaw moments). For each of the one or more pitch offset control modules, the controller may be configured to determine the respective dynamic maximum pitch amplitude value based on the determined statistical dispersion parameters indicative of the turbulence level.

If the turbulence level is greater than a first turbulence level indicative of a high turbulence level, then the respective dynamic maximum pitch amplitude value for the one or more tilt-yaw individual pitch offset control modules may be determined to be greater than if the turbulence level is less than a second threshold turbulence level less than or equal to the first turbulence level. Optionally, the second threshold turbulence level may be less than the first turbulence level. Further optionally, the respective dynamic maximum pitch amplitude value for the one or more tilt-yaw individual pitch offset control modules may be determined to decrease monotonically from the second threshold turbulence level to the first turbulence level. For instance, the respective dynamic maximum pitch amplitude value may decrease linearly from the second threshold turbulence level to the first turbulence level.

The one or more pitch offset control modules may comprise one or more further pitch offset control modules, different from the one or more tilt-yaw individual pitch offset control modules, each for mitigating loads experienced by one or more components of the wind turbine.

The one or more further pitch offset control modules may comprise a whirling mode pitch offset control module configured to determine a whirling mode pitch reference offset value for each respective rotor blade to mitigate a whirling mode caused by edgewise vibrations of the rotor blades. The determination may be based on at least one of: a received tower dynamics signal indicative of dynamics of a tower of the wind turbine; and, an edgewise load signal, from a sensor of one or more of the rotor blades, indicative of edgewise loading on each of the respective rotor blades.

If the received collective pitch signal and the received power signal indicate that an operating point of the wind turbine is within a whirling threshold distance of a non-rated region of a power curve of the wind turbine, then the dynamic maximum pitch amplitude value for the whirling mode pitch offset control module may be determined to be lower than if the operating point is in a rated region of the power curve and farther than the whirling threshold distance from the non-rated region.

The dynamic maximum pitch amplitude value of the whirling mode pitch offset control module may be determined as a function of a difference between an edge frequency of the rotor blades and an nP frequency of the rotor, where n is a positive integer. Optionally, the dynamic maximum pitch amplitude value of the whirling mode pitch offset control module may be greater for smaller values of the difference between the edge frequency and the nP frequency.

If the wind turbine enters a safe mode of operation then the dynamic maximum pitch amplitude value of the whirling mode pitch offset control module may be determined to increase.

The one or more further pitch offset control modules may comprise a high frequency collective pitch offset control module configured to: receive a tower loading signal indicative of tower loading in a fore-aft direction of the wind turbine; and, determine a high frequency collective pitch reference offset value for the rotor blades, based on the received tower loading signal, to reduce fatigue in the wind turbine tower caused by high frequency collective content, greater than 2P frequency content.

If the received collective pitch signal and the received power signal indicate that an operating point of the wind turbine is within a high frequency collective threshold distance of a non-rated region of a power curve of the wind turbine, then the dynamic maximum pitch amplitude value for the high frequency collective pitch offset control module may be determined to be higher than if the operating point is in a rated region of the power curve and farther than the high frequency collective threshold distance from the non-rated region.

The dynamic maximum pitch amplitude value of the high frequency collective pitch offset control module may be determined as a function of a difference between a natural mode frequency of the wind turbine tower and a 3P frequency of the rotor. Optionally, the dynamic maximum pitch amplitude value of the high frequency collective pitch offset control module may be greater for smaller values of the difference between the natural mode frequency and the 3P frequency.

The respective dynamic maximum pitch amplitude values of the one or more further pitch offset control modules may be determined in dependence on the respective determined dynamic maximum pitch amplitude values of the one or more tilt-yaw individual pitch offset control modules. Optionally, if the turbulence level is greater than the first turbulence level then the respective dynamic maximum pitch amplitude values of the one or more further pitch offset control modules may be less than if the turbulence level is less than the second turbulence level.

According to another aspect of the invention there is provided a wind turbine comprising a controller as defined above.

According to another aspect of the invention there is provided a method for a wind turbine having a rotor and two or more rotor blades. The method is for adjusting pitch of the rotor blades. The method comprises: determining a collective pitch reference for the rotor blades; receiving a collective pitch signal indicative of collective pitch angle of the rotor blades; receiving a power signal indicative of power output of the wind turbine; for each of one or more pitch offset control modules of a controller of the wind turbine, determining a respective dynamic maximum pitch amplitude value based on the received collective pitch signal and on the received power signal, and determining a respective pitch reference offset value in accordance with the respective dynamic maximum pitch amplitude value; and, determining an overall pitch reference based on the collective pitch reference and the one or more pitch reference offset values, and transmitting a control signal to adjust the pitch of the rotor blades in accordance with the overall pitch reference.

According to another aspect of the invention there is provided a non-transitory, computer-readable storage medium storing instructions thereon that when executed by one or more processors cause the one or more processors to execute the method defined above.

### BRIEF DESCRIPTION OF THE DRAWINGS

Examples of the invention will now be described with reference to the accompanying drawings, in which:

FIG. 1 schematically illustrates a wind turbine in accordance with an aspect of the invention;

FIG. 2 schematically illustrates a controller of the wind turbine of FIG. 1 in accordance with an aspect of the invention;

FIG. 3 schematically illustrates pitch offset control modules of the controller of FIG. 2;

FIGS. 4(a)-4(c) show an example of how pitch offset control modules of FIG. 3 are used to counter a build-up of backward whirling content; and,

FIG. 5 shows the steps of a method performed by the controller of FIG. 2.

### DETAILED DESCRIPTION

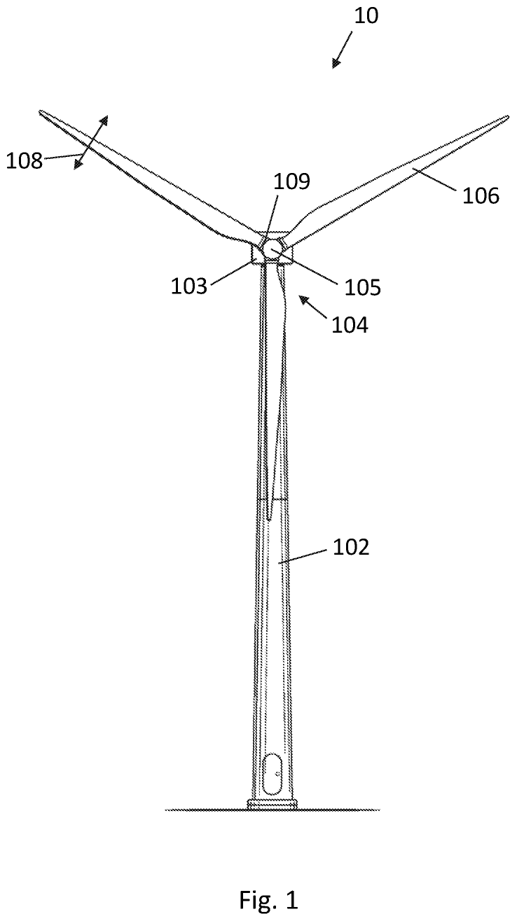

FIG. 1 illustrates, in a schematic view, an example of a wind turbine 10. The wind turbine 10 includes a tower 102, a nacelle 103 disposed at the apex of, or atop, the tower 102, and a rotor 104 operatively coupled to a generator housed inside the nacelle 103. In addition to the generator, the nacelle 103 houses other components required for converting wind energy into electrical energy and various components needed to operate, control, and optimise the performance of the wind turbine 10. The rotor 104 of the wind turbine 10 includes a central hub 105 and three rotor blades 106 that project outwardly from the central hub 105. Moreover, the wind turbine 10 comprises a control system or controller (not shown in FIG. 1). The controller may be placed inside the nacelle 103, in the tower 102 or distributed at a number of locations inside (or externally to) the turbine 10 and communicatively connected to one another. The rotor blades 106 are pitch-adjustable. The rotor blades 106 can be adjusted in accordance with a collective pitch setting, where each of the blades are set to the same pitch value. The rotor blades 106 may additionally be adjustable in accordance with individual pitch settings, where each blade 106 may be provided with an individual pitch setpoint.

In some examples, the wind turbine 10 includes blade load sensors placed at, or in the vicinity of, each blade root 109 in a manner such that the sensor detects loading in the blade 106. Blade load signals from such sensors may be used to determine how to adjust the pitch of each of the individual blades 106. Depending on the placement and the type of sensor, loading may be detected in the flap (flapwise) direction (in/out of plane) or in the edge (edgewise) direction 108 (in-plane). Such sensors may be strain gauge sensors or optical Bragg-sensors, for instance. As the sensors are placed on the rotating blades 106, such load signals for each of the adjustable rotor blades 106 are measured in the rotating reference frame of the rotor 104.

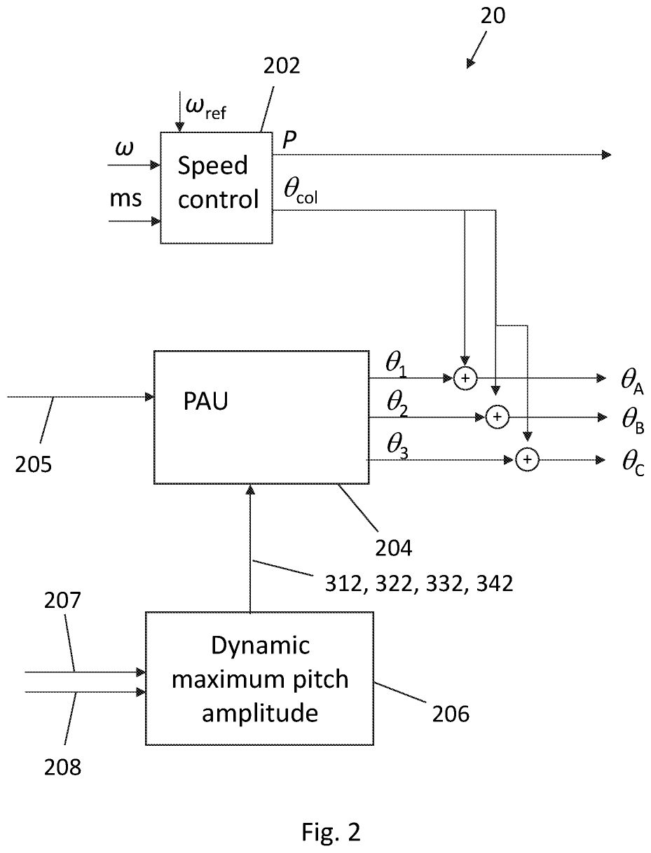

FIG. 2 schematically illustrates elements of an example of an overall controller 20 of the wind turbine 10 implemented to determine pitch actuation signals capable of maximising power generation and reducing or mitigating loads experienced by one or more components of the wind turbine 10, e.g. tower 102, rotor blades 106, etc. In the illustrated implementation, a collective pitch control module in the form of a speed controller (control module/block) 202 of the overall controller 20 minimises a speed error (ω-ω_{ref}) between the actual rotor speed, ω, and a reference rotor speed, ω_{ref}, in order to output a requested power P (in the form of a power setpoint) and a collective pitch reference, θ_{col}. The collective pitch reference as determined by the speed controller 202, in view of the rotor speed, may also take further sensor values into account. This is referred to in FIG. 2 as a measurement set, ms, being input into the speed controller 202. The feedback speed controller 202 may be implemented by a PI (proportional-integral), PID (proportional-integral-derivative), or similar control scheme. In one example, the collective pitch control module 202 may alternatively be a model predictive controller which, based on minimising a cost function, is arranged to determine the collective pitch reference and/or the power reference.

FIG. 2 further illustrates a control block/module or controller 204, of the overall controller 20, which may be referred to as a pitch actuation unit (PAU). In the pitch actuation unit 204, pitch modification signals, or pitch reference offset values, are determined based on one or more input signals 205. As will be described in greater detail below, the PAU 204 includes one or more pitch reference offset control modules. Each pitch reference offset control module determines a respective pitch modification signal or pitch reference offset value aimed at mitigating a respective type of loading experienced by the wind turbine 10, e.g. loading resulting from specific frequency content exhibited by one or more components of the wind turbine 10. The pitch modification signal determined by each respective pitch reference offset control module may be individual pitch modification signals for each respective rotor blade 106 or may be a collective pitch modification signal. The (combination of these) offsets or modification signals θ₁, θ₂, θ₃ are superimposed onto the collective pitch reference from the collective pitch control module 202 to provide resulting or overall pitch modification signals or pitch reference θ_{A}, θ_{B}, θ_{C} that can be applied to the pitch actuators of the rotor blades 106 collectively and/or individually. The pitch reference offset control modules are described in greater detail below.

The described controller 20 may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the method.

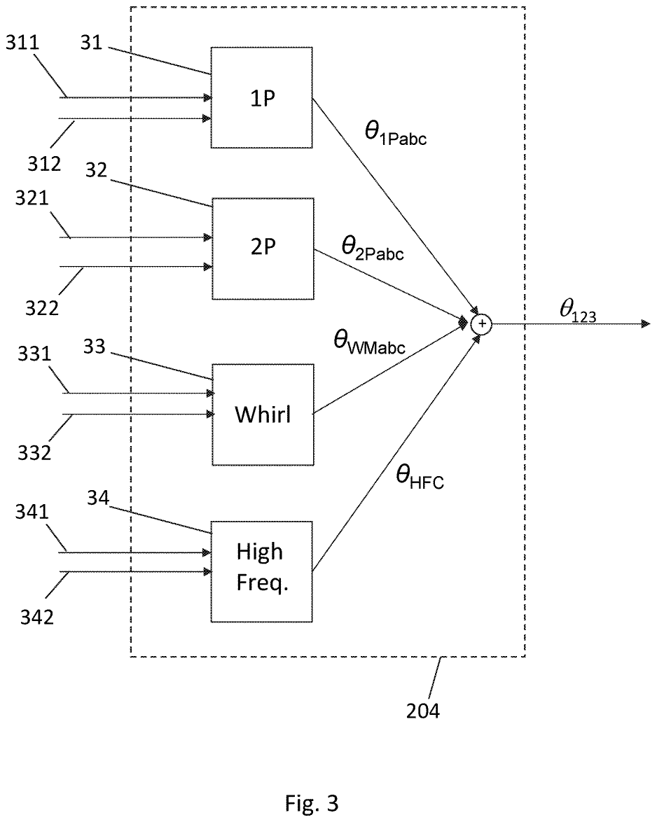

FIG. 3 schematically illustrates in greater detail the PAU 204 of the overall controller 20 in the described example. In particular, FIG. 3 illustrates that the PAU 204 includes four pitch reference offset control modules, or pitch offset controllers, in the described example.

A first of these pitch offset controllers may be a so-called 1P controller 31. The 1P controller is an individual pitch controller for targeting 1P frequency content. 1P frequency is a rotational frequency of the wind turbine rotor 104, i.e. the frequency with which a full rotation of the rotor 104 is completed. The 1P controller 31 may take as input load signals 311 from one or more blade sensors of the wind turbine 10. The 1P controller 31 determines out-of-plane moment(s) based on the received signals. In one example, the input load signal is in the form of blade flap load measurements, with gravity being taken into account in a prescribed manner in order to determine the out-of-plane moment. In another example, the input load signal may include flap and edge load measurements in order to obtain an out-of-plane moment. More generally, the input load signal may be regarded as being a blade out-of-plane loading signal. In the case of three rotor blades 106, a three-dimensional vector is obtained, where each value of the vector indicates an out-of-plane blade root bending moment associated with a respective one of the three blades 106.

The 1P controller 31 determines a 1P pitch reference offset value or signal for each respective rotor blade, based on the received out-of-plane loading signal, specifically based on the out-of-plane moment. The determined 1P pitch reference offset value is for targeting OP tilt-yaw loads in a fixed frame of reference. This may also be used to target 1P flap loads for relatively low collective pitch angles. In order to determine the 1P offset signal, the 1P controller 31 may transform the received load signals from a rotating or rotor reference frame into a fixed reference frame, e.g. via an m-blade (multi-blade) coordinate transformation such as a Coleman transformation. This causes 1P frequency content in the input signal to appear at OP in the transformed signal. A control action for counteracting this content, or mitigating its effect, is determined, e.g. via a PI (proportional integral) control routine, before an inverse m-blade transformation may then be applied to obtain control components in the rotor frame, in particular in the form of pitch modification signals to be applied to the pitch angle settings for the respective rotor blades to counteract 1P content. The output signals from the 1P controller 301 are therefore the individual pitch modification signals θ_{1Pa}, θ_{1Pb}, θ_{1Pc}.

A second of the pitch offset controllers may be a so-called 2P controller 32. In a corresponding manner to the 1P controller 31, the 2P controller 32 is an individual pitch controller for targeting 2P frequency content. 2P cyclic disturbances in a rotor coordinate frame (rotating reference frame) are twice the rotor rotational frequency. Such disturbances appear at 3P in a fixed coordinate frame. As such, a 2P controller 32 may be used to counteract vibrational modes at 3P in the fixed frame, where 3P is the frequency at which the rotor blades pass the tower in a three-blade wind turbine, i.e. three times per complete rotation of the rotor 104. Like in the 1P controller 31, in the 2P controller 32 an input signal 321 in the form of blade sensor data is received from the blade load sensors to obtain a three-dimensional out-of-plane blade root bending moment vector.

An m-blade transformation may be applied by the 2P controller 32 to obtain components in the fixed frame. In order to target 2P content in the input signal (as required in the 2P controller 32), a further transformation may therefore be applied to isolate this content in the transformed signal. This is needed because it is not only 2P content from the input signal 321 that appears at 3P in the transformed signal, but 4P content in the input signal is also included. The further transformation may be a rotation that has a rotation angle that rotates with an angular velocity of 3P. The 2P content in the input signal 321 then appear at OP in this further transformed frame of reference. Once the 2P content has been isolated in this way then a control action for counteracting it, or mitigating its effect, is determined, in particular to obtain control components in this frame of reference. Inverse transformations to return to the rotor frame are then applied to the control components to obtain pitch modification signals θ_{2Pa}, θ_{2Pb}, θ_{2Pc} to be applied to the pitch angle settings for the respective rotor blades to counteract 2P content.

The 1P and 2P controllers 31, 32 may be referred to collectively as tilt-yaw controllers or tilt-yaw individual pitch offset control modules.

The PAU 204 may include a further pitch reference offset control module in the form of a so-called whirling mode pitch offset control module or whirling mode controller 33. In particular, the whirling mode controller 33 is for determining a pitch modification signal that is for mitigating or counteracting edgewise whirling content caused by edgewise vibrations of the rotor blades. When the rotor of a wind turbine is turning, oscillations of the blades relative to their edgewise axes can cause movement of the blade in the same plane as the plane of rotation of the rotor. It will be appreciated that the rotor shaft is effectively mounted at one of its ends and is unsupported at the hub end where the blades are attached. As edgewise oscillation of the blades excites the rotor with a force that is transverse to its longitudinal axis, then in resonant conditions this may result in the rotational axis of the rotor shaft describing an erratic pattern of motion. This phenomenon may be referred to as ‘whirling’. This phenomenon may typically be present for higher wind speeds.

Phase differences between edgewise oscillations of the blades determines whether whirling occurs in the same direction as the rotor rotation, which may be referred to as ‘forward whirl’ or a ‘forward whirling mode’, or whether whirling occurs in a direction opposite to that of the rotor rotation, which may be referred to as ‘backward whirl’ or a ‘backward whirling mode’.

Whirling mode vibrations may be detectable in different types of sensor measurements received as an input signal 331 to the whirling mode controller 33. In one example, the input signal 331 is in the form of edgewise loading measurements from the blade sensors. In another example, as whirling of the rotor shaft imparts lateral forces to the nacelle 103 via the rotor 104 and therefore causes it to sway from side to side, then whirling mode vibrations may be detected by monitoring the behaviour of the nacelle 103 or upper portion of the tower 102. In such an example, the input signal 331 may therefore be in the form of a measurement from an accelerometer located at a top of the tower 102 or in the nacelle 103 and indicative of dynamics of the wind turbine tower 102, e.g. side to side motion of the tower 102.

The whirling mode controller 33 determines a whirling mode pitch reference offset value for each respective rotor blade 106 to mitigate the whirling mode caused by blade edgewise vibrations, in particular in the form of individual pitch modification signals θ_{WMa}, θ_{WMb}, θ_{WMc} to be applied to the pitch angle settings for the respective rotor blades 106. In an example in which the input signal 331 is blade edge load measurements, an m-blade coordinate transformation may be applied to the input signal to obtain a transformed signal in a fixed frame. This transformation makes it possible to distinguish backward whirling from forward whirling, both being different manifestations of the edge 1^{st} mode. In particular, when the phase is set as the rotor azimuth in the transformation, backward whirling appears at the edge frequency minus 1P, while forward whirling appears at the edge frequency plus 1P. An alternative approach is to apply two counter rotating Coleman transform operations, a first with a rotation angle at the positive edge frequency and a second with a rotation angle at the negative edge frequency. In the first, the backward whirling mode goes to 0 Hz and the forward whirling mode goes to twice the edge frequency. In the second, the forward whirling mode goes to 0 Hz and the backward whirling mode goes to twice the edge frequency. This large frequency separation can be beneficial for filtering purposes. The edge frequency may be regarded as a known parameter that may be accessed via a look-up table or similar in a memory module. A control action may be applied to the transformed signal to mitigate whirling content, before then being transformed back into the rotor frame via an inverse m-blade transform, to obtain the pitch modification signals θ_{WMa}, θ_{WMb}, θ_{WMc}.

The PAU 204 may include a further pitch reference offset control module in the form of a so-called high frequency collective pitch offset control module or high frequency collective controller 34. The high frequency collective controller 34 is for determining a pitch modification signal that is for reducing levels of fatigue in the wind turbine tower 102 caused by high frequency content in the tower movement. Specifically, the controller 34 reduces tower fatigue resulting from excitations that occur when the 3P frequency coincides with, or is in relatively close proximity to, a coupled mode frequency content arising as a result of a coupling between the tower 102 and floating platform in the case of a floating platform wind turbine system, e.g. offshore system. 3P frequency is the frequency at which a rotor blade passes the tower 102 for a wind turbine with three blades. The high frequency collective controller 34 can also be used to reduce tower fatigue resulting from excitations that occur when the 3P frequency coincides with, or is in relatively close proximity to, a natural mode of the tower 102 of an onshore wind turbine.

The controller 34 provides for controlling high frequency content—which may be defined as frequency content greater than 2P, i.e. having a higher frequency than 2P—by controlling or adjusting a phase lead/lag of a collective pitch reference offset used to control or adjust pitch of the wind turbine rotor blades 106. The oscillation to be targeted is in the tower fore-aft direction. The input signal 341 to the high frequency collective controller 34 is therefore a signal indicative of tower loading in a fore-aft direction of the wind turbine 10. In one example, this is in the form of an acceleration measurement signal, from one or more accelerometers at a top of the tower 102 or in the nacelle 103, that is indicative of fore-aft acceleration of the tower 102 and the nacelle 103. The high frequency collective controller 34 may generate a further signal based on the input signal, in particular orthogonal to the input signal, e.g. using a second-order generalised integrator (SOGI). A phase shift is then applied to the mutually orthogonal signals. An optimal phase for the collective 3P pitch reference offset—i.e. a phase that is most appropriate for reducing tower fatigue—may vary with operating point of the wind turbine 10. A collective pitch reference offset value or signal θ_{HFC} for the rotor blades 106 based on one of the mutually orthogonal signals is then determined for reducing high frequency collective content.

Each pitch offset controller 31, 32, 33, 34 has a respective maximum pitch amplitude defining a maximum amplitude of offset adjustment permitted by said controller. This is to ensure that a hydraulic pitch system of the wind turbine 10 that is for actuating or adjusting pitch of the rotor blades in accordance with an overall pitch reference output by the overall controller 20 does not demand more in the way of pitch adjustment than can be delivered by a hydraulic pump system of the wind turbine 10. As pitch adjustments of greater amplitude place a higher demand on the pump system, then defining a maximum pitch amplitude (amplitude saturation value) for each pitch offset controller ensures that the pump capacity is not exceeded, where pump capacity is reflective of a rate at which fluid can be pumped into the pump system.

Previously, these maximum pitch amplitudes have been defined as static (constant) values, apportioned as appropriate between different pitch offset controllers based on a total capacity of the pump system, i.e. a reserve has been allocated to each controller. In an illustrative example, a 1P pitch offset controller may have its amplitude constrained to 5 degrees, a 2P pitch offset controller may have its amplitude constrained to 1 degree, and further pitch offset controllers (e.g. whirling mode controller, high frequency collective controller) may have their amplitudes constrained to an appropriate static value. The pump capacity reserve allocated to each pitch offset controller may alternatively be expressed as a proportion/percentage of the total pump capacity. However, this may not result in the most effective use of the pitch offset controllers to reduce or counteract extreme or fatigue loading on one or more wind turbine components. In particular, in a case in which one such pitch offset controller is deactivated or being implemented to effect relatively small pitch adjustments, resulting unused capacity may be able to be used by another pitch offset controller that is not being implemented most effectively because of the respective maximum pitch amplitude constraints placed thereon. That is, reserving capacity in a static manner means that pump capacity may not be allocated optimally, resulting in hindered load alleviating capacity.

The present invention is advantageous in that a dynamic maximum pitch amplitude value is determined for each pitch offset controller of a wind turbine. In particular, each dynamic maximum pitch amplitude value is determined based on an operating point of the wind turbine. Specifically, each dynamic maximum pitch amplitude value is determined based on a collective pitch angle of the rotor blades and on a power output of the wind turbine. As the requirement for operation of, or intervention from, different types of pitch offset controllers is different at different operating points of the wind turbine, for a given operating point the respective maximum pitch amplitude values can be determined to relax adjustment constraints on those pitch offset controllers whose operation is needed at said operating point, i.e. the maximum pitch amplitude value is increased. At the same time, to ensure that pump capacity is not exceeded, adjustment constraints on the other pitch offset controllers whose operation is not needed, or needed to a lesser degree, at said operating point are tightened i.e. the maximum pitch amplitude value is decreased.

Scheduling the dynamic maximum pitch amplitude values based on wind turbine power output is advantageous in that it ensures uniqueness of operating point (compared to using generator speed, for instance). In some examples, each pitch offset controller may have a default maximum pitch amplitude value associated therewith, with deviations (increases or decreases) from the default values being enforced for certain operating points. Further advantages associated with the present invention will become apparent from the following description.

Returning to FIG. 2, the overall controller 20 includes a dynamic maximum pitch amplitude module 206, or dynamic amplitude saturation module, for determining the dynamic maximum pitch amplitude for each pitch offset controller 31, 32, 33, 34. In some examples, the dynamic maximum pitch amplitude module 206 may be regarded as being part of the PAU 204. The dynamic maximum pitch amplitude module 206 takes as input a signal 207 indicative of wind turbine power output. For instance, this may be in the form of a measured and/or estimated electrical power output of the wind turbine 10. The dynamic maximum pitch amplitude module 206 also takes as input a signal 208 indicative of collective pitch angle of the rotor blades 106. In one example, this could be the collective pitch reference θ_{col} output by the speed controller 202.

A determination of wind turbine operating point is made based on the input measurements/signals 207, 208. The dynamic maximum pitch amplitude module 206 then determines a (different) dynamic maximum pitch amplitude value for each respective pitch offset controller 31, 32, 33, 34. For instance, this determination may be performed by means of a look up table in storage means accessible by the module 206, where a given operating point corresponds to a given value for each of the respective pitch offset controllers 31, 32, 33, 34. With additional reference to FIG. 3, each pitch offset controller 31, 32, 33, 34 is provided with the respective determined dynamic maximum pitch amplitude value 312, 322, 332, 342. The pitch modification signals determined by each pitch offset controller 31, 32, 33, 34 are constrained by the respective dynamic maximum pitch amplitude values 312, 322, 332, 342.

In examples of the invention, higher priority may be given to controllers that deal with extreme loading on one or more wind turbine components. In particular, the tilt-yaw individual pitch offset controllers 31, 32 are for reducing extreme loading, and so priority may be given to these controllers 31, 32 in terms of ensuring they are allocated sufficient pump capacity to reduce extreme loading. Extreme loading can become more of an issue at higher wind speeds. Control of tilt and yaw extreme loads therefore requires greatest effort/intervention from the controllers 31, 32 at higher wind speeds. As such, the dynamic maximum pitch amplitude for one or both of the tilt-yaw pitch offset controllers 31, 32 may be increased for operating points corresponding to higher wind speeds. Expressed differently, the dynamic maximum pitch amplitudes for the tilt-yaw pitch offset controllers 31, 32 may be determined to be greater for higher wind speeds relative to the determined dynamic maximum pitch amplitudes for these controllers 31, 32 at lower wind speeds. In this context, higher wind speeds may refer to wind speeds in a rated region of operation of the wind turbine 10 (e.g. on a power curve of the wind turbine 10), and may be relatively distant from a derated region of operation. An increase in the dynamic maximum pitch amplitudes for the tilt-yaw pitch offset controllers 31, 32 at higher wind speeds may result in a corresponding decrease in determined dynamic maximum pitch amplitudes for other pitch offset controllers of the wind turbine 10, e.g. the whirling mode and/or high frequency collective controllers 33, 34, to ensure that overall pump capacity is not exceeded.

An important aspect of examples of the invention is that a level of turbulence of wind in the vicinity of the wind turbine 10 is taken into account by the dynamic maximum pitch amplitude module 206 when determining the respective dynamic maximum pitch amplitude values. The most extreme loading scenarios experienced by the wind turbine 10 may be in conditions of relatively high wind speeds and relatively high turbulence. The highest priority may therefore be given to the tilt-yaw pitch offset controllers 31, 32—by means of highest dynamic maximum pitch amplitudes—in such conditions.

The intervention of tilt-yaw pitch offset control can also be beneficial for reducing extreme loading (e.g. extreme flap loading) at other wind speeds, specifically wind speeds in the vicinity of a transition point between derated and rated operational regions of the wind turbine 10. This may also be referred to as wind speeds at the ‘knee’ of the power curve. It is observed that the pitch offset amplitudes needed by the tilt-yaw controllers 31, 32 to mitigate extreme loading at such wind speeds tend to be below amplitude saturation levels, e.g. below default maximum pitch amplitude values for these controllers 31, 32. It may typically be the case, therefore, that increasing the maximum values above default values is not needed to effect effective extreme loading control in such conditions. However, an exception may be in conditions of moderate wind speeds, e.g. near to the ‘knee’ of the power curve, paired with relatively high turbulence levels, where greater tilt-yaw pitch offset intervention would be beneficial. Therefore, the dynamic maximum pitch amplitudes for the tilt-yaw pitch offset controllers 31, 32 may be determined to be greater in such conditions, e.g. relative to conditions of moderate wind speeds and moderate or low turbulence levels.

In an example, if the turbulence level is greater than a first turbulence level indicative of a high turbulence level, then the respective dynamic maximum pitch amplitude values for the tilt-yaw controllers 31, 32 are determined to be greater than if the turbulence level is less than a second threshold turbulence level less than or equal to the first turbulence level. In an example, the first and second threshold levels are equal. In a more preferable example, the first and second threshold levels are not equal and the maximum amplitude values ramps up from the second threshold to the first threshold, e.g. in a monotonic manner. This could for instance be implemented as a linear interpolation or increase of the maximum amplitude from the second to the first threshold, optionally where the maximum amplitude is constant for turbulence values greater than the first threshold and/or less than the second threshold.

In a corresponding manner, at lower levels of turbulence there may be little or no need for the intervention of the tilt-yaw controllers 31, 32. As such, the maximum amplitude values for these controllers 31, 32 in such conditions may be reduced in order to free up pump capacity for other pitch offset controllers, e.g. controllers that address fatigue loading issues.

Turbulence may be determined based on data obtained from the blade load sensors of the wind turbine 10. In particular, this may be based on flap bending moment sensor data obtained from the blade load sensors. Specifically, a statistical dispersion parameter, e.g. standard deviation, of the sensor data is indicative of a level of turbulence of the wind field, and so such a parameter is determined in order ascertain turbulence levels. The determination of turbulence may be performed by the dynamic maximum pitch amplitude module 206 or a different part of the overall controller 20.

Edge whirling tends to be a phenomenon that is most apparent high wind speeds and/or high pitch angles of the wind turbine. It may therefore be beneficial to have an increased maximum pitch amplitude value in such conditions; however, as noted above, priority in terms of pump capacity (and so maximum amplitude values) may be given to the tilt-yaw pitch offset controllers 31, 32, possibly at the expense of the whirling mode controller 33. Edge fatigue is dominated by gravity and the edge whirling phenomenon is not critical for the most frequent wind speeds experienced by the wind turbine. As such, it may be that pump capacity need not be pre-allocated to the whirling mode controller 33 for operating points near to the ‘knee’ of the power curve. In one example, this may be expressed or implemented as determining the dynamic maximum pitch amplitude value for the controller 33 to be lower for operating points in a non-rated region of the power curve, or in a rated region but within a threshold distance of the non-rated region, than the value for operating points in the rated region but more than the threshold distance from the non-rated region.

It is noted that ‘direct’ excitation of edge whirling modes arise during frequency clashes between the edge frequency of the rotor blades 106 and relevant nP frequency peaks, where n is a positive integer. The determination of the dynamic maximum pitch amplitude value for the whirling mode controller 33 may therefore be dependent on a determined difference between an edge frequency of the rotor blades 106 and an nP frequency of the rotor 104. Specifically, the dynamic maximum pitch amplitude value of the whirling mode controller 33 may be greater for smaller values of the difference between the edge frequency and the nP frequency, i.e. where the edge and nP frequencies are closer. In an example, a highest value of the dynamic maximum pitch amplitude for the whirling mode controller 33 is provided when a backward whirling frequency—i.e. the edge frequency minus 1P—crosses or intersects (or is within a certain distance of) the 3P frequency, and/or when a forward whirling frequency—i.e. the edge frequency plus 1P—crosses or intersects (or is within a certain distance of) the 6P frequency.

It is also noted that, while the 2P controller 32 can address tilt-yaw loading, it can also be utilised to counter the build-up of a whirling mode. Therefore, the determination of the dynamic maximum pitch amplitude value for the 2P controller 32 may also be based on the frequencies causing excitation of the whirling modes as described above. In particular, the dynamic maximum pitch amplitude value for the 2P controller 32 may be increased in such conditions, whereas the dynamic maximum pitch amplitude value for the 1P controller 31 may decrease, or remain at a relatively small value, in these conditions (which may free up capacity for the 2P controller).

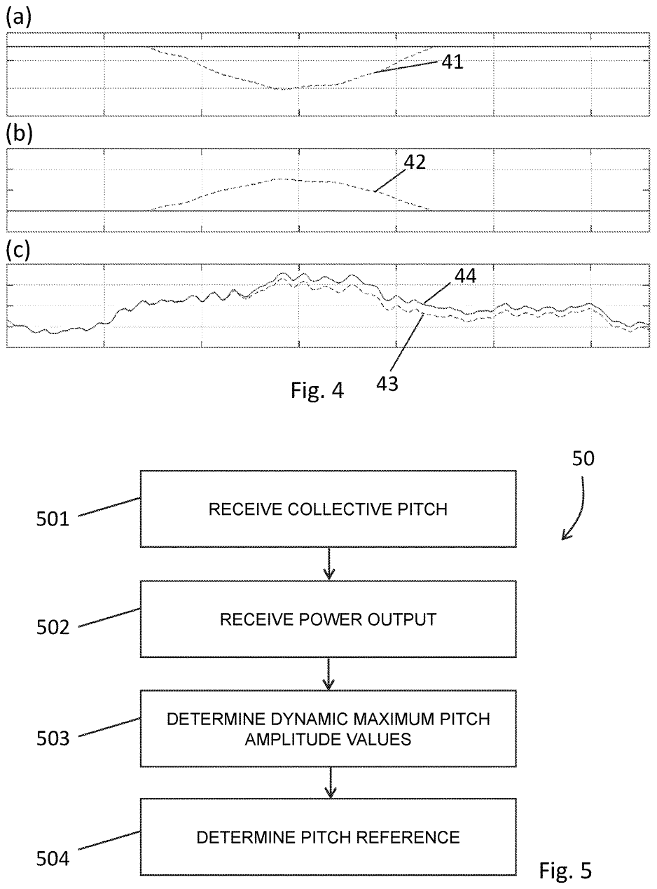

FIG. 4 illustrates an example in which the 2P controller 32 is used to counter the build-up of a backward whirling mode. In particular, FIG. 4(a) shows a plot of the maximum pitch amplitude value 41 of the 1P controller 31 over time, and FIG. 4(b) shows a plot of the maximum pitch amplitude value 42 of the 2P controller 32 over time. When the 3P frequency becomes close to the backward whirling frequency—i.e. the blade edge frequency minus 1P—then the dynamic maximum pitch amplitude value 42 of the 2P controller 32 is increased to counter the backward whirling mode, as illustrated in FIG. 4(b). In order to ensure there is sufficient pump capacity for this increase in maximum pitch amplitude, the dynamic maximum pitch amplitude value 41 of the 1P controller 31 is correspondingly decreased, as illustrated in FIG. 4(a). FIG. 4(c) shows a plot of how the backward whirling content varies over time. In particular, FIG. 4(c) shows a comparison between how the increase in backward whirling content build-up when the 3P frequency becomes close to the backward whirling frequency is countered when the maximum pitch amplitude value 42 of the 2P controller 32 is increased. Specifically, it is seen that when the 2P controller 32 maximum amplitude 42 is increased, the build-up of backward whirling content 43 is less than the equivalent build-up of backward whirling content 44 if the maximum pitch amplitude value 42 of the 2P controller 32 is not increased, i.e. if a static maximum pitch amplitude 44 is used.

When operation of the wind turbine 10 is derated, e.g. in a safe mode of operation, most of the loading on wind turbine components decreases. However, an exception to this is edge loading, which may still be significant in such a mode of operation. As such, in one example the controller 20 may be determined to increase the dynamic maximum pitch amplitude for the whirling mode controller 33 when the wind turbine 10 enters a safe mode or operation is otherwise derated. This may be accompanied by corresponding decreases in the dynamic maximum pitch amplitude values of other controllers, such as the tilt-yaw controllers 31, 32 and/or high frequency collective controller 34, to ensure overall pump capacity is not exceeded. Alternatively, in one example the 2P tilt-yaw controller 32 may retain a relatively high dynamic maximum pitch amplitude value (or increase the value) in a safe or other derated mode (e.g. in addition to the whirling mode controller 33). In particular, this may be beneficial when the safe mode operation is paired with conditions of moderate to high turbulence.

High frequency collective pitch control is particularly useful for addressing fatigue issues, often occurring in floating systems. As a result of the distribution of the time spent at each operating point following the known Weibull distribution, it is noted that the need for high frequency collective pitch control is greatest at the knee of the power curve. In one example, this may be expressed or implemented as determining the dynamic maximum pitch amplitude value for the high frequency collective controller 34 to be higher for operating points in a non-rated region of the power curve, or in a rated region but within a threshold distance of the non-rated region, than the value for operating points in the rated region but more than the threshold distance from the non-rated region. An increase of the dynamic maximum pitch amplitude value for the controller 34 near to the knee of the power curve in this way can also be beneficial in that it can reduce the risk of micro-shredding, which occurs as a result of insufficient lubrication of the blade bearing. This benefit could be significant because the high frequency collective controller 34 may intervene relatively regularly during wind turbine operation given that it is addressing a fatigue issue.

This fatigue issue can occur as a result of proximity between the 3P frequency and a natural mode between the wind turbine tower 102 and a floating platform in the case of a floating system. As such, the amount of pump capacity allocated to the high frequency collective pitch controller 34 may beneficially be set as a function of a margin/difference between 3P and natural mode frequency content. In particular, this may be expressed or implemented as the dynamic maximum pitch amplitude value of the controller 34 being determined to be greater for smaller values of the difference between the natural mode frequency and the 3P frequency compared to a maximum amplitude value for greater values of the difference.

Also, in conditions of relatively low or moderate turbulence—which may be regarded as being relatively common conditions, and so being relevant for fatigue—the 1P controller 31 may not be prioritised for pump capacity, instead meaning that the high frequency collective controller 34 may be allocated greater pump capacity (by means of an increased maximum pitch amplitude) in such conditions to mitigate fatigue loading.

FIG. 5 summarises the steps of a method 50 implemented by the controller 20 of the wind turbine 10. At step 501, the method 50 involves receiving a collective pitch signal indicative of collective pitch angle of the rotor blades 106, e.g. a collective pitch reference determined by the speed controller 202. At step 502, the method 50 involves receiving a power signal indicative of power output of the wind turbine 10. This may for instance be a measured electrical power output of the wind turbine 10 (to the grid).

At step 503, for each pitch offset controller 31, 32, 33, 34, the method 50 involves determining a respective dynamic maximum pitch amplitude value based on the received collective pitch signal and on the received power signal, i.e. based on wind turbine operating point. In examples in which at least one tilt-yaw pitch offset controller 31, 32 and at least one further pitch offset controller is included, e.g. whirling mode and/or high frequency collective controllers 33, 34, the dynamic maximum pitch amplitude value for each further pitch offset controller may be determined in dependence on the dynamic maximum pitch amplitude value determined for each of the tilt-yaw controllers 31, 32. That is, higher priority in terms of pump capacity may be given to the tilt-yaw controllers 31, 32. As such, determined increase in maximum amplitude for the tilt-yaw controllers 31, 32 may automatically result in a decrease in maximum amplitude for the further pitch offset controllers 33, 34 irrespective of wind conditions.

The respective dynamic maximum pitch amplitude values may be determined further based on a determined turbulence level of the wind in the vicinity of the wind turbine 10. In particular, higher priority in terms of pump capacity may be given to the tilt-yaw controllers 31, 32 than to the further pitch offset controllers 33, 34 in conditions of relatively high turbulence.

In overview, in conditions of low-to-moderate wind speed and low-to-moderate turbulence, the dynamic pitch amplitude of the 1P controller 31 may be decreased, whereas the dynamic pitch amplitude of the high frequency collective controller 34 may be increased. In conditions of low-to-moderate wind speed and moderate-to-high turbulence, the dynamic pitch amplitude of the 1P controller 31 may be increased to counter increased flap extreme loading associated with such conditions. For low-to-moderate wind speeds—and irrespective of turbulence levels—the dynamic pitch amplitude of the whirling mode controller 33 may be decreased (optionally to zero).

Also, in conditions of relatively high wind speed and low-to-moderate turbulence, the dynamic pitch amplitudes of the respective 1P and 2P controllers 31, 32 may be increased, while possible decreasing the dynamic pitch amplitude of the high frequency collective controller 34 (and maintaining some pump capacity for the whirling mode controller 33). In conditions of relatively high wind speed and moderate-to-high turbulence, the dynamic pitch amplitudes of one or more of the 1P, 2P and whirling mode controllers 31, 32, 33 may be increased. In some cases, the 1P controller 31 may be given lower priority than the 2P and whirling mode controllers 32, 33, with for instance the reduced 1P controller 31 intervention being compensated for by implementing power derating.

Each pitch offset controller 31, 32, 33, 34 then determines a respective pitch reference offset value in accordance with the respective dynamic maximum pitch amplitude value. That is, each determined pitch reference offset value is constrained to be less (in magnitude) than the respective determined dynamic maximum pitch amplitude value. At step 504, the method 50 involves determining an overall pitch reference based on the collective pitch reference and each of the pitch reference offset values. A control signal is transmitted to adjust the pitch of the rotor blades 106 in accordance with the overall pitch reference.

Many modifications may be made to the described examples without departing from the scope of the appended claims.

In the described example, the pitch actuation unit includes pitch reference offset control modules in the form of a 1P controller, a 2P controller, a whirling mode controller and a high frequency collective pitch controller. It will be understood, however, that different examples may include fewer or greater—and indeed any appropriate combination—of such pitch reference offset control modules. For instance, in some examples a side-side tower damping controller using pitch may be included, but it will be understood that various different types of pitch controller may be included.

1. A controller for a wind turbine having a rotor and two or more rotor blades, the controller being for adjusting pitch of the rotor blades, the controller comprising:
a collective pitch control module for determining a collective pitch reference for the rotor blades; and,
one or more pitch offset control modules;
the controller being configured to:
receive a collective pitch signal indicative of collective pitch angle of the rotor blades;
receive a power signal indicative of power output of the wind turbine; and,
for each of the one or more pitch offset control modules, determine a respective dynamic maximum pitch amplitude value based on the received collective pitch signal and on the received power signal,
wherein each pitch offset control module is configured to determine a respective pitch reference offset value in accordance with the respective dynamic maximum pitch amplitude value,
the controller being configured to determine an overall pitch reference based on the collective pitch reference and the one or more pitch reference offset values, and to transmit a control signal to adjust the pitch of the rotor blades in accordance with the overall pitch reference.

2. A controller according to claim 1, wherein the one or more pitch offset control modules comprise one or more tilt-yaw individual pitch offset control modules each for mitigating loads experienced by one or more components of the wind turbine, and comprising one or both of:
a 1P pitch offset control module configured to: receive an out-of-plane load signal, from a sensor of one or more of the rotor blades, indicative of out-of-plane loading on each of the respective rotor blades; and, determine a 1P pitch reference offset value for each respective rotor blade, based on the received out-of-plane load signals, to target 1P frequency content in the received out-of-plane load signal; and,
a 2P pitch offset control module configured to: receive the out-of-plane load signals; and, determine a 2P pitch reference offset value for each respective rotor blade, based on the received out-of-plane load signals, to target 2P frequency content in the received out-of-plane load signal.

3. A controller according to claim 2, the controller being configured to:
determine, based on the received out-of-plane load signals, a statistical dispersion parameter of out-of-plane loading for each of the rotor blades, the statistical dispersion parameters being indicative of a turbulence level in a wind field in which the wind turbine operates; and,
for each of the one or more pitch offset control modules, determine the respective dynamic maximum pitch amplitude value based on the determined statistical dispersion parameters indicative of the turbulence level.

4. A controller according to claim 3, wherein if the turbulence level is greater than a first turbulence level indicative of a high turbulence level, then the respective dynamic maximum pitch amplitude value for the one or more tilt-yaw individual pitch offset control modules is determined to be greater than if the turbulence level is less than a second threshold turbulence level less than or equal to the first turbulence level; optionally, wherein the second threshold turbulence level is less than the first turbulence level, and wherein the respective dynamic maximum pitch amplitude value for the one or more tilt-yaw individual pitch offset control modules is determined to decrease monotonically from the second threshold turbulence level to the first turbulence level.

5. A controller according to claim 1, wherein the one or more pitch offset control modules comprise one or more further pitch offset control modules, different from the one or more tilt-yaw individual pitch offset control modules, each for mitigating loads experienced by one or more components of the wind turbine.

6. A controller according to claim 5, wherein the one or more further pitch offset control modules comprise a whirling mode pitch offset control module configured to determine a whirling mode pitch reference offset value for each respective rotor blade to mitigate a whirling mode caused by edgewise vibrations of the rotor blades, the determination being based on at least one of: a received tower dynamics signal indicative of dynamics of a tower of the wind turbine; and, an edgewise load signal, from a sensor of one or more of the rotor blades, indicative of edgewise loading on each of the respective rotor blades.

7. A controller according to claim 6, wherein if the received collective pitch signal and the received power signal indicate that an operating point of the wind turbine is within a whirling threshold distance of a non-rated region of a power curve of the wind turbine, then the dynamic maximum pitch amplitude value for the whirling mode pitch offset control module is determined to be lower than if the operating point is in a rated region of the power curve and farther than the whirling threshold distance from the non-rated region.

8. A controller according to claim 6, wherein the dynamic maximum pitch amplitude value of the whirling mode pitch offset control module is determined as a function of a difference between an edge frequency of the rotor blades and an nP frequency of the rotor, where n is a positive integer; optionally, wherein the dynamic maximum pitch amplitude value of the whirling mode pitch offset control module is greater for smaller values of the difference between the edge frequency and the nP frequency.

9. A controller according to any of claim 6, wherein if the wind turbine enters a safe mode of operation then the dynamic maximum pitch amplitude value of the whirling mode pitch offset control module is determined to increase.

10. A controller according to any of claim 5, wherein the one or more further pitch offset control modules comprises a high frequency collective pitch offset control module configured to: receive a tower loading signal indicative of tower loading in a fore-aft direction of the wind turbine; and, determine a high frequency collective pitch reference offset value for the rotor blades, based on the received tower loading signal, to reduce fatigue in the wind turbine tower caused by high frequency collective content, greater than 2P frequency content.

11. A controller according to claim 10, wherein if the received collective pitch signal and the received power signal indicate that an operating point of the wind turbine is within a high frequency collective threshold distance of a non-rated region of a power curve of the wind turbine, then the dynamic maximum pitch amplitude value for the high frequency collective pitch offset control module is determined to be higher than if the operating point is in a rated region of the power curve and farther than the high frequency collective threshold distance from the non-rated region.

12. A controller according to claim 10, wherein the dynamic maximum pitch amplitude value of the high frequency collective pitch offset control module is determined as a function of a difference between a natural mode frequency of the wind turbine tower and a 3P frequency of the rotor; optionally, wherein the dynamic maximum pitch amplitude value of the high frequency collective pitch offset control module is greater for smaller values of the difference between the natural mode frequency and the 3P frequency.

13. A controller according to claim 5, wherein the respective dynamic maximum pitch amplitude values of the one or more further pitch offset control modules is determined in dependence on the respective determined dynamic maximum pitch amplitude values of the one or more tilt-yaw individual pitch offset control modules; optionally, wherein if the turbulence level is greater than the first turbulence level then the respective dynamic maximum pitch amplitude values of the one or more further pitch offset control modules is less than if the turbulence level is less than the second turbulence level.

14. (canceled)

15. A method for a wind turbine having a rotor and two or more rotor blades, the method being for adjusting pitch of the rotor blades, the method comprising:
determining a collective pitch reference for the rotor blades;
receiving a collective pitch signal indicative of collective pitch angle of the rotor blades;
receiving a power signal indicative of power output of the wind turbine;
for each of one or more pitch offset control modules of a controller of the wind turbine, determining a respective dynamic maximum pitch amplitude value based on the received collective pitch signal and on the received power signal, and determining a respective pitch reference offset value in accordance with the respective dynamic maximum pitch amplitude value; and,
determining an overall pitch reference based on the collective pitch reference and the one or more pitch reference offset values, and transmitting a control signal to adjust the pitch of the rotor blades in accordance with the overall pitch reference.

16. A wind turbine, comprising:
a tower;
a nacelle;
a rotor extending from the nacelle and having a plurality of rotor blades;
a controller configured for adjusting pitch of the plurality of rotor blades, the controller comprising:
a collective pitch control module for determining a collective pitch reference for the rotor blades; and,
one or more pitch offset control modules;
the controller being configured to:
receive a collective pitch signal indicative of collective pitch angle of the rotor blades;
receive a power signal indicative of power output of the wind turbine; and,
for each of the one or more pitch offset control modules, determine a respective dynamic maximum pitch amplitude value based on the received collective pitch signal and on the received power signal,
wherein each pitch offset control module is configured to determine a respective pitch reference offset value in accordance with the respective dynamic maximum pitch amplitude value,
the controller being configured to determine an overall pitch reference based on the collective pitch reference and the one or more pitch reference offset values, and to transmit a control signal to adjust the pitch of the rotor blades in accordance with the overall pitch reference.
